(19) United States
(12) Patent Application Publication
(10) Pub. No.: US 2018/0257754 A1
(43) Pub. Date: Sep. 13, 2018

(54) FORMERS FOR AIRCRAFT FUSELAGE

(71) Applicant: Black Hills Aero, Inc., Spearfish, SD (US)

(72) Inventor: Ted J. Miller, Spearfish, SD (US)

(21) Appl. No.: 15/451,687

(22) Filed: Mar. 7, 2017

(51) Int. Cl. B64C 1/06; B64C 1/12; B64F 5/00

(52) U.S. Cl. CPC B64C 1/065; B26F 3/004; B64F 5/00; B64C 1/12

(57) ABSTRACT

A former for an aircraft fuselage is disclosed. An example former has a first face and a second face. Each of the faces is shaped as a component of the aircraft fuselage. The example former has a cellular structure between the first face and the second face. The cellular structure has a low density of wall material relative to density of a solid former, and can withstand high out-of-plane compression and out-of-plane shear forces. An adhesive attaches the first face to a first side of the cellular structure, and the second face to a second side of the cellular structure. The edge of the former may support a skin of the aircraft fuselage.

### BACKGROUND

Original equipment manufacturer formers are fabricated from plywood. Over time, these wood formers can decay, absorb moisture, twist, split and/or break. This can cause a safety issue with dragging, binding, and misalignment of the rudder and trim tab control cables, and could cause the pilot to lose directional control of the aircraft. These issues also result in the need for premature replacement of the aircraft fabric covering.

### BRIEF DESCRIPTION OF THE DRAWINGS

FIG. 1 shows a portion of an aircraft fuselage implementing example formers disclosed herein.

FIG. 2 shows example formers disclosed herein supporting a skin of an aircraft fuselage.

FIGS. 3A-3C illustrate construction of an example former.

FIGS. 4A-4B illustrate various example formers.

### DETAILED DESCRIPTION

Formers are disclosed herein which may include a unique cellular structure (e.g., also referred to as a “honeycomb”). Each former may be component-specific. By way of illustration, factory (Aeronca, Bellanca, Champion and American Champion) part numbers that can be replaced with honeycomb formers are 7-1259, 5-393, 4-555, 2-2046, 4-556, 4-557, 4-1541, 7-455, and 5-10000. In an example, the formers disclosed herein can be made to fit components for all aircraft listed in the Federal Aviation Administration Type Certificate A-759.

In an example, the honeycomb structure is made of a commercial or aviation grade material and may have cells that are about ¼″ to ⅜″ thick (i.e., between adjacent face sheets (or “faces”). Face sheets may be manufactured of a 0.025″ to 0.032″ thick aluminum alloy (e.g. 5052 or 2024T3 aluminum). An epoxy or other adhesive may be implemented to assemble the honeycomb sheets (e.g., a 20274/50077 resin hardener or similar epoxy). The fabrication of the formers may be by water jet or duplicate router process, or other suitable process.

In an example, the formers have a high strength-to-weight ratio. The formers may be resistant to fire, moisture, corrosion, and fungus. The formers may have a high level of machineability.

Before continuing, it is noted that as used herein, the terms “includes” and “including” mean, but is not limited to, “includes” or “including” and “includes at least” or “including at least.” The term “based on” means “based on” and “based at least in part on.”

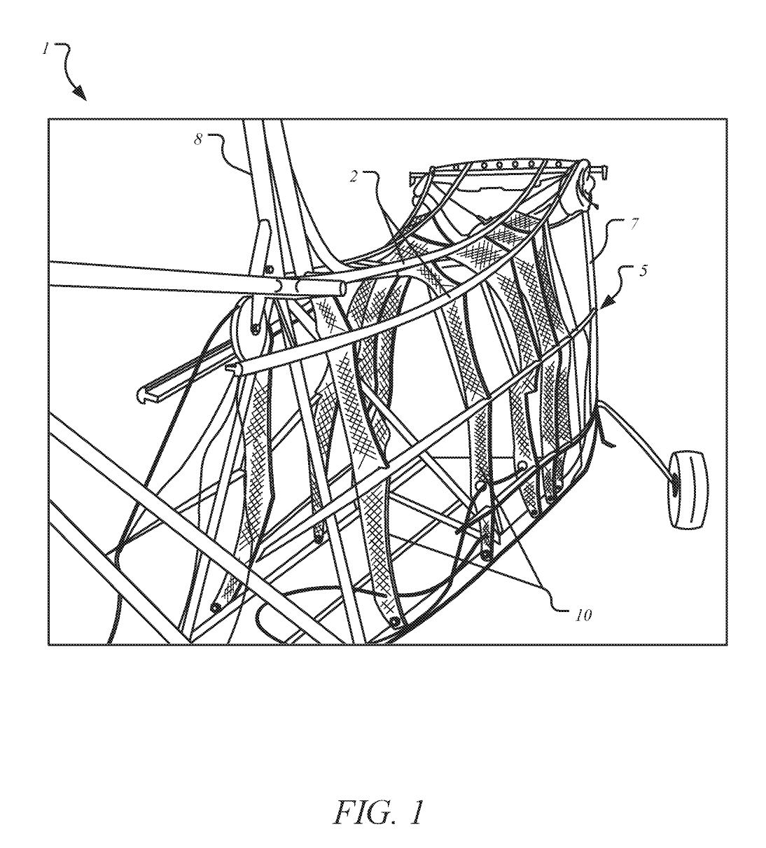

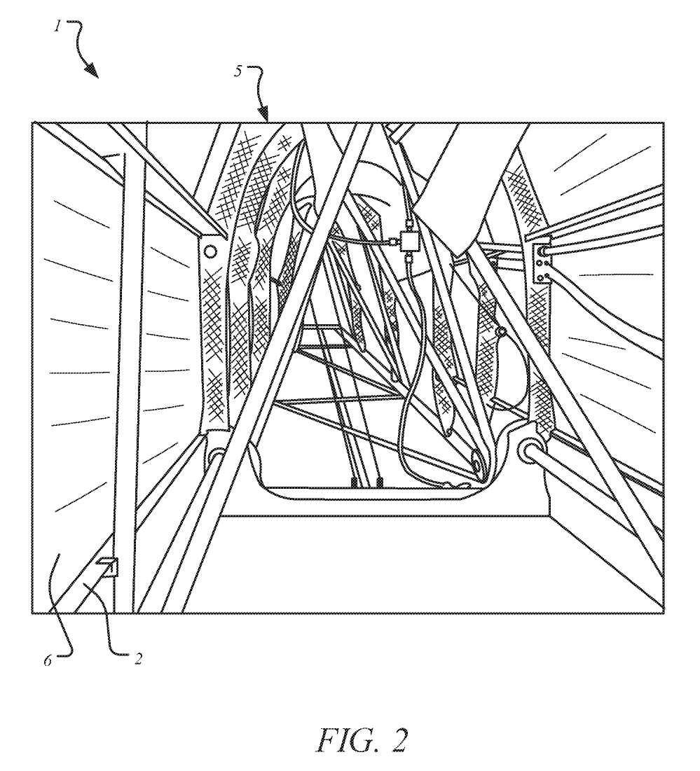

FIG. 1 shows a portion of an aircraft fuselage 1 implementing example formers 10 disclosed herein. The aircraft fuselage 1 may be constructed with a series of formers 10 to provide shape to the fuselage 1. Stringers 2 may be attached to the formers 10 to form a rigid frame 5, The frame 5 is then covered with a skin 6 (e.g., cloth or other lightweight material such as aluminum), as shown in FIG. 2.

FIG. 2 shows an interior view of the aircraft fuselage 1. In this example, the view is looking in from the front section 7 (see FIG. 1) toward the tail section 8 (see FIG. 1). The example formers 10 are shown forming a part of the frame supporting the skin 6 of the aircraft fuselage 1.

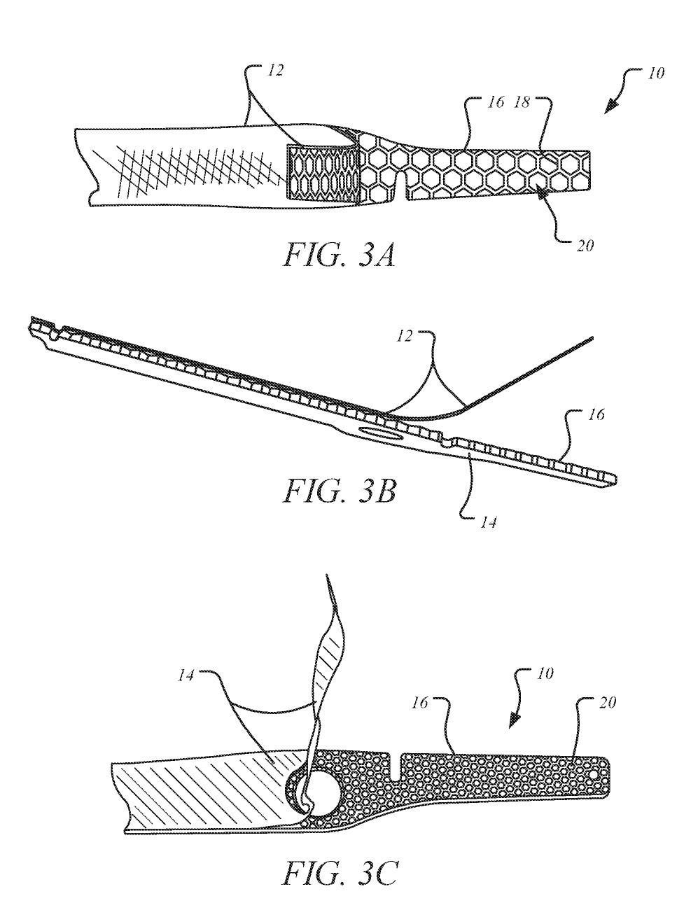

FIGS. 3A-3C illustrate construction of an example former 10 for an aircraft fuselage (e.g., the aircraft fuselage 1 shown in FIGS. 1-2). In an example, the former 10 includes a first face 12 (shown pealed back in FIGS. 3A-3B. The former 10 also includes a second face 14 (shown pealed back in FIG. 3C). Each of the faces 12 and 14 may be shaped as a component of the aircraft fuselage. The former 10 may also include a cellular structure 16 between the first face 12 and the second face 14.

In an example, an adhesive attaches the first face 12 to a first side of the cellular structure 16, An adhesive also attaches the second face 14 to a second side of the cellular structure 16. In an example, the adhesive is a 20274/50077 resin hardener. However, other adhesives may also be implemented.

In an example, the cellular structure 16 has a plurality of interconnected walls 18 forming a plurality of individual cells 20. The cellular structure 16 may include an array of hollow cells 20 formed between thin vertical walls 18. The individual cells 18 are generally columnar and extend between the faces 12 and 14. In an example, the individual cells 20 are hexagonal in shape. However, the cells may be any suitable shape, and more than one shape cell may be provided in the cellular structure 16.

In an example, the cellular structure has a low density of wall material relative to the density of a solid former. As such, the cellular structure is configured to withstand high out-of-plane compression and out-of-plane shear forces.

By way of illustration, the formers 10 are manufactured of aviation grade material. The cellular structure 16 may include ¼″ to ⅜″ thick cells 20. The faces may be manufactured of a 0,025″ to 0.032″ thick aluminum alloy. The aluminum alloy may be 5052 or 2024T3 aluminum. It is noted, however, that other sizes, shapes, and materials may also be implemented.

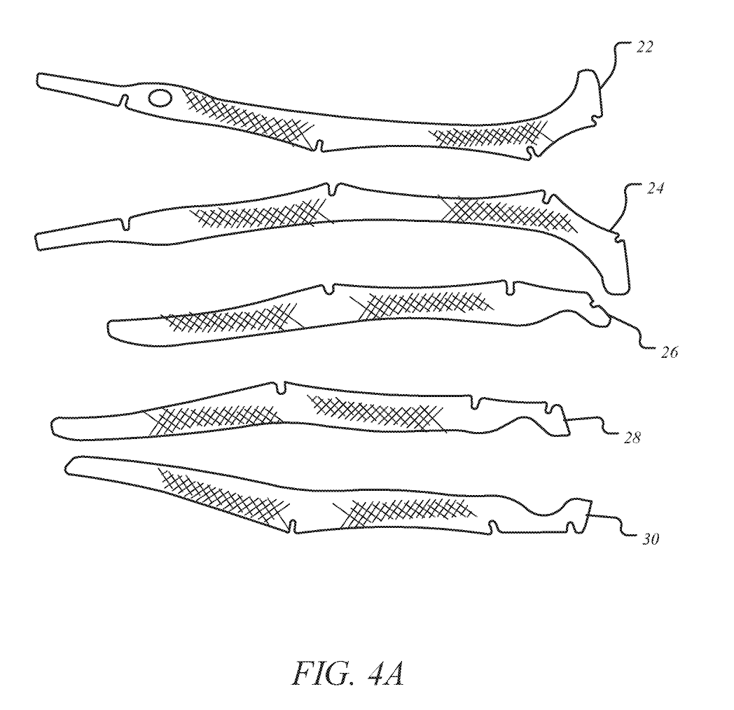

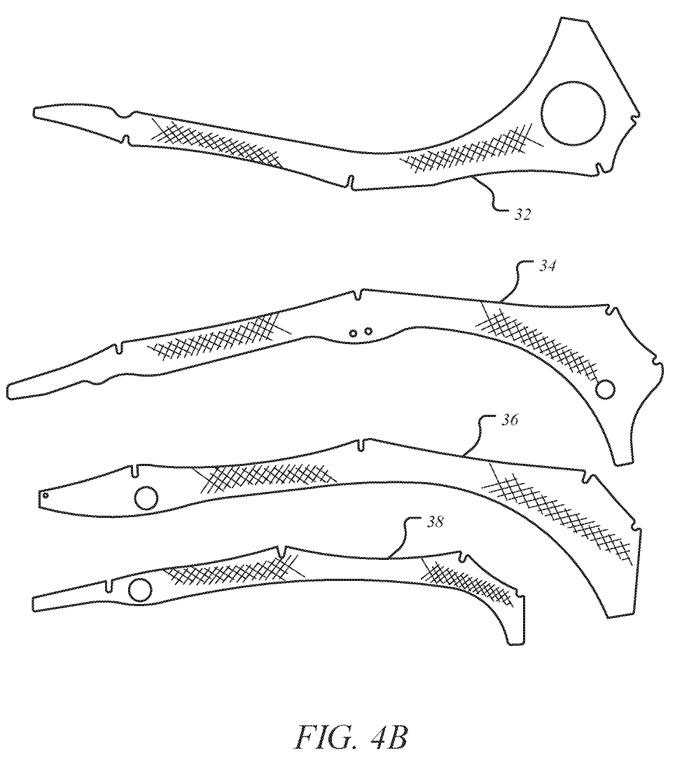

FIGS. 4A-4B illustrate various example formers 22-38 which may be manufactured according to the process described herein. It is noted that the formers 22-38 shown in FIGS. 4A-4B are plan views and as such, the cellular structure (structure 16 shown in FIGS. 3A-3C) are not visible. However, the formers 22-38 shown in FIGS. 4A-4B include a cellular structure (e.g., as described above for FIGS. 3A-3C). In an example, the faces of the formers 22-38 are shaped to correspond to components for aircraft listed in the Federal Aviation Administration Type Certificate A-759. However, other shapes of formers manufactured according to the implementations discussed herein are also contemplated, as will be understood by those having ordinary skill in the art after becoming familiar with the teachings herein.

Before continuing, it should be noted that the examples described above are provided for purposes of illustration, and are not intended to be limiting. Other devices and/or device configurations may be utilized to carry out the operations described herein.

A method of manufacturing a former for an aircraft fuselage is also disclosed. An example method may include providing a board having a cellular structure between the first face and the second face. The example method may also include cutting the board into the shape of component of the aircraft fuselage. The example method may also include attaching the first face to a first side of the cellular structure, and attaching the second face to a second side of the cellular structure. In an example, cutting is by water jet or by duplicate router process. The resulting component is provided with a low density of wall material relative to density of a solid former and withstands high out-of-plane compression and out-of-plane shear forces.

The operations shown and described herein are provided to illustrate example implementations. It is noted that the operations are not limited to the ordering shown. Still other operations may also be implemented.

It is noted that the examples shown and described are provided for purposes of illustration and are not intended to be limiting. Still other examples are also contemplated.

1. A former for an aircraft fuselage, comprising;
a first face and a second face, each of the faces shaped as a component of the aircraft fuselage;
a cellular structure between the first face and the second face.

2. The former of claim 1, further comprising an adhesive attaching the first face to a first side of the cellular structure and attaching the second face to a second side of the cellular structure.

3. The former of claim 2 wherein the adhesive is a 20274/50077 resin hardener.

4. The former of claim 1, wherein an edge of the former supports a skin of the aircraft fuselage.

5. The former of claim 1, wherein the faces are shaped to correspond to components for aircraft listed in the Federal Aviation Administration Type Certificate A-759.

6. The former of claim 1, wherein the cellular structure has a plurality of interconnected walls forming a plurality of individual cells.

7. The former of claim 6, wherein the cellular structure comprises an array of hollow cells formed between thin vertical walls.

8. The former of claim 6, wherein the individual cells are columnar.

9. The former of claim 6, wherein the individual cells are hexagonal in shape.

10. The former of claim 1, wherein the cellular structure has a low density of wall material relative to density of a solid former.

11. The former of claim 1, wherein the cellular structure withstands high out-of-plane compression and out-of-plane shear forces.

12. The former of claim 1, wherein the first face and the second face are manufactured of aviation grade material.

13. The former of claim 1, wherein the cellular structure has ¼″ to ⅜″ size cells.

14. The former of claim 1, wherein the first face and the second face are manufactured of a 0.025″ to 0.032″ thick aluminum alloy.

15. The former of claim 1, wherein the aluminum alloy is 5052 or 2024T3 aluminum.

16. A method of manufacturing a former for an aircraft fuselage, comprising;
providing a board having a cellular structure between the first face and the second face; and
cutting the board into the shape of component of the aircraft fuselage.

17. The method of claim 16, further comprising:
attaching the first face to a first side of the cellular structure; and
attaching the second face to a second side of the cellular structure.

18. The method of claim 16, wherein cutting is by water jet.

19. The method of claim 16, wherein cutting is by duplicate router process.

20. The former of claim 1, wherein the resulting component is provided with a low density of wall material relative to density of a solid former and withstands high out-of-plane compression and out-of-plane shear forces.
